(19) United States
(12) Patent Application Publication
(10) Pub. No.: US 2013/0318149 A1
(43) Pub. Date: Nov. 28, 2013

(54) CLOUD-BASED ACTIVITY PROGRAMMING

(71) Applicant: Polun Chang, Taipei (TW)

(72) Inventor: Polun Chang, Taipei (TW)

(73) Assignee: National Yang-Ming University, Taipei (TW)

(21) Appl. No.: 13/478,289

(22) Filed: May 23, 2012

(51) Int. Cl. G06F 15/16

(52) U.S. Cl. 709/203

(57) ABSTRACT

An apparatus for providing a user program to a user includes a mobile device configured to execute thereon a head end of an application for collecting user information and for providing a user program interface for delivery of user program information to the user, and a server in wireless data communication with the mobile device for providing user programming information thereto, the user programming being selected at least in part on the basis of the user information collected by said mobile device.

### FIELD OF DISCLOSURE

This disclosure relates to information systems, and in particular, to programming systems.

### BACKGROUND

Existing programming systems rely on user data entry. These systems are also non-adaptive. Once an activity is programmed, it tends not to change in response to changed circumstances unless the user specifically causes it to change.

User interfaces for existing programming systems tend to copy the appearance of their paper-based forebears. As such, these user interfaces do not readily take advantage of the processing ability of a modern smart phone or similar mobile broadband devices.

### SUMMARY

In one aspect, the invention features an apparatus for providing a user program to a user. Such an apparatus includes a mobile device configured to execute thereon a head end of an application for collecting user information and for providing a user program interface for delivery of user program information to the user, and a server in wireless data communication with the mobile device for providing user programming information thereto, the user programming being selected at least in part on the basis of the user information collected by the mobile device.

Embodiments of the apparatus include those in which the server includes a knowledge base for assessing the solicited user information and providing changes in program instructions to the mobile data in response to the user information.

Also among the embodiments of the apparatus are those in which the mobile device is configured to execute a programming interface for displaying a user program to the user. Among these are those in which the programming interface includes an activity map calibrated to represent a certain time interval.

The programming interface can also include an icon disposed at a location in the activity map, the location representing a time at which an activity corresponding to the icon is to occur. In some embodiments, the activity map includes a circular region. Others include an indicator on the activity map, the indicator being configured to change position on the activity map in response to passage of time.

In some embodiments, the icon is placed on the activity map at least in part in response to collected user information. In others, the location of the icon changes at least in part based on collected user information. In yet other embodiments, the icon disappears after the time at which the activity it represents has occurred.

In yet other embodiments, the mobile device is configured to execute an interface for collecting user information, the interface including an active corner region and an active side region, wherein the active corner region and the active side region each execute corresponding instructions in response to actuation by the user.

Additional embodiments include those in which the mobile device is configured to execute an interface for collecting user information, the interface including a plurality of active corner regions and a plurality of active side regions, each side region extending between two of the active corner regions, wherein the active corner regions and the active side regions each execute corresponding instructions in response to actuation by the user.

In another aspect, the invention features an apparatus for providing a user program to a user. Such an apparatus includes a server in wireless data communication with a mobile device for providing user programming information thereto, the user programming being selected at least in part on the basis of user information collected by the mobile device.

In yet another aspect, the invention features a computer-readable medium having encoded thereon software for providing a user program to a user. Such software includes instructions for providing, to a mobile device, user programming selected at least in part on the basis of user information collected by the mobile device.

In another aspect, the invention features a computer-implemented method for providing a user program to a user. Such a method includes establishing communication with a mobile device configured to execute thereon a head end of an application for collecting user information and for providing a user program interface for delivery of user program information to the user, and providing user programming information to the mobile device, the user programming being selected at least in part on the basis of the user information collected by the mobile device.

Among the practices of the method are those that also include providing a knowledge base for assessing the solicited user information, and providing changes in program instructions to the mobile data in response to the user information.

Yet other practices of the invention also include displaying a user program to the user. In some practices, displaying a user program includes displaying an activity map calibrated to represent a certain time interval.

In other practices, displaying a user program includes displaying an icon disposed at a location in the activity map, the location representing a time at which an activity corresponding to the icon is to occur.

Additional practices include those in which displaying a user program includes placing an icon on the activity map at least in part in response to collected user information, and those in which displaying a user program includes placing an icon on the activity map at a location based at least in part based on collected user information.

Other practices include in response to user actuation of an active corner region on the mobile device, executing first instructions, and in response to a user actuation of an active side region on the mobile device, executing second instructions.

Also among the practices of the invention are those that include, in response to user actuation of any one of plural corner regions, executing instructions corresponding to the actuated corner region, and in response to user actuation of any of a plurality of side regions, each of which extends between two of the active corner regions, executing user instructions corresponding to the actuated side region.

These and other practices of the invention will be apparent from the following detailed description and the accompanying drawings, in which:

### DESCRIPTION OF THE FIGURES

FIG. 1 is a functional block diagram of an activity programming system;

FIG. 2 shows parts of a collection interface;

FIG. 3 shows an example of a collection interface having the parts shown in FIG. 2;

FIGS. 4-5 shows the collection interface of FIG. 3 after activating a region on a category strip thereof;

FIG. 6 shows the collection interface of FIG. 2 used to display a pre-defined list of symptoms;

FIGS. 7 and 8 show activity programming interfaces; and

FIG. 9 shows an activity programming interface optimized for a rectangular display area.

### DETAILED DESCRIPTION

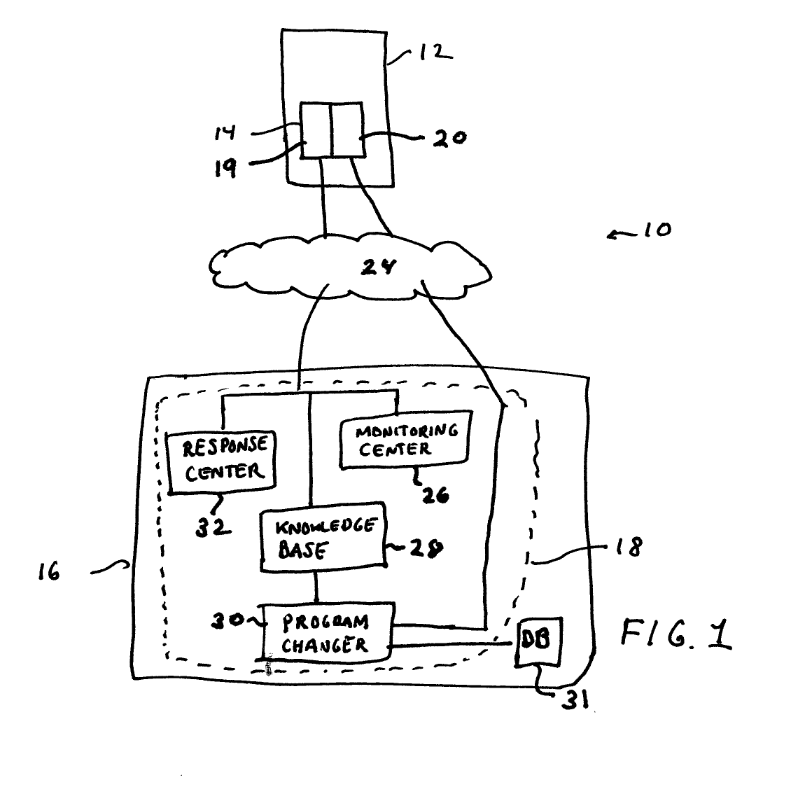

Activity programming includes providing a program of activities to be carried out at particular times, i.e. an “activity program,” in response to solicited information. One activity programming system 10, shown in FIG. 1, features a mobile device 12 on which executes a head-end 14 of an application, and a server 16 on which remotely executes a tail-end 18 of the application. The head-end 14 includes a collection interface 19 for collecting information from a user, and a user program interface 20 that provides an activity program, which may include instructions and reminders, to the user. Communication between the head-end 14 and the tail-end 18 takes place via the cloud 24.

The tail-end 18 includes a monitor 26 that receives user information provided by the collection interface 19 and stores it in a user database 31. In some embodiments, the tail-end 18 also retrieves information from the user database 31 for display on the mobile device 12.

The tail-end 18 further includes a knowledge base 28 that functions as an expert system for evaluating the information provided by the user and making decisions based on that information, and a program changer 30 for providing a program of instructions, or “activity program,” to be carried out by the user, or alternatively, for providing changes to an activity program already provided earlier to the user's mobile device 12.

An activity programming system 10 as described herein is particularly useful in the area of health care delivery. In this application, an activity program can include instructions to take certain medications at certain times, to take a blood pressure at certain times, to engage in particular exercises, and the like. Information solicited from the user might be information about current medical conditions, including quantitative information such as temperature and blood pressure or qualitative information, such as the presence of swelling and the like.

However, the activity programming system 10 described herein is also useful in other areas in which a user must perform certain activities that can change in response to changing circumstances.

A response center 32 fields inquiries from the user. These inquiries can be pre-recorded or pre-set inquiries made by activating selected areas of the collection interface 19 or user program interface 20. These pre-recorded inquiries can be provided in a hierarchical fashion, so that selecting one inquiry will display additional inquiries related to the selected inquiry. In some cases, the response center 32 automatically responds to these inquiries. However, in other cases, the response center 32 will direct a query to a live human. For example, in a health care application, the user may be directed to trained medical practitioner communicate with the user, either directly, for example by a telephone call, or indirectly, for example by causing the activity program to change.

In response to certain data provided by the head-end 14, the knowledge-base 28 may determine that a change is necessary to the activity program instructions provided by the program changer 30. The program changer 30 then provides this information back to the head-end 14 for display on the mobile device 12 using the head-end's programming interface 20.

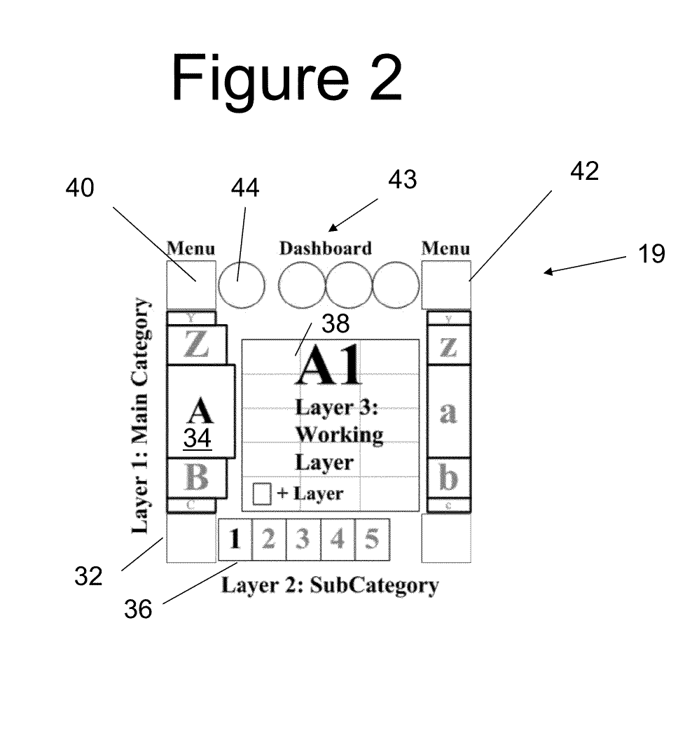

To promote usability and to accommodate the constraints of space on a typical mobile device 12, the collection interface 19, shown in FIG. 2, includes a main category strip 32 that features regions 34, each of which is marked by an icon, text, or characters to identify a particular category. Stroking the finger over the category strip 32 causes the region 34 under the finger to momentarily enlarge relative to other regions. The entire category strip 32 can also be scrolled one way or the other to expose additional categories. A suitable gesture, such as a tap, on a particular region 34 exposes fields for soliciting information from the user for use in generating a user program. These fields are pertinent to the active category and are displayed in a working layer 38. A subcategory strip 36 operates in essentially the same way as the main category strip 32.

The collection interface 19 further includes menu buttons 40, 42, that, in response to selected gestures, expose various menus. Also included in the collection interface 19 is a dashboard 43 containing buttons 44 that, in response to a gesture, cause certain actions to occur.

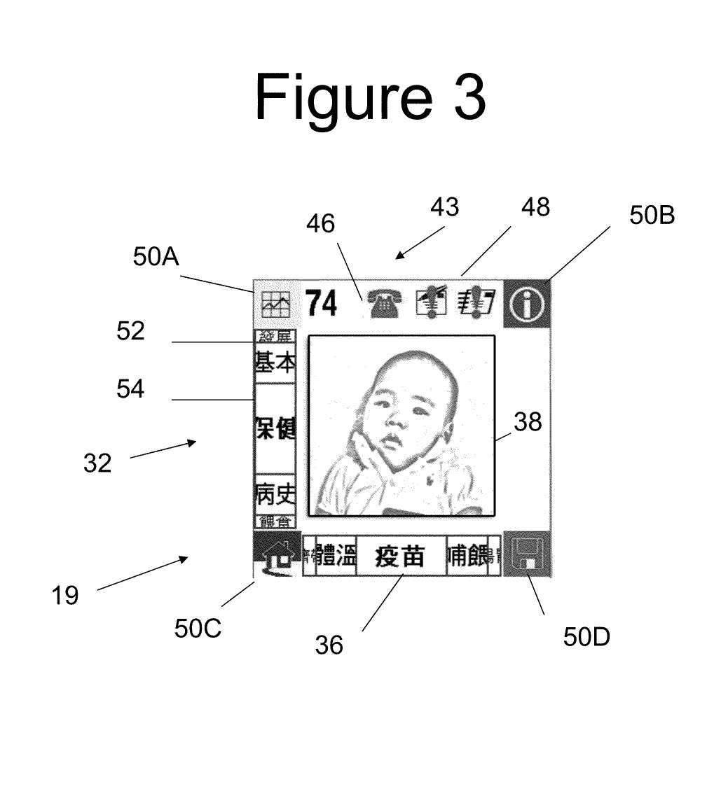

FIG. 3 shows a representative collection interface 19 in which the dashboard 43 features buttons for various communication functions, such as for making telephone calls 46 or sending messages 48, as well as four menu buttons 50A-D. In the illustrated example, the main category strip 32 and subcategory strip 36 use sinographs for communication. However, it will be understood that the particular symbol used to convey meaning is not important, so long as it can be understood. The working layer 38 in this case shows a photograph of the user.

In some embodiments, the collection interface 19 can also collect information from the user database 31. For systems used in health care, such information can include the user's compliance information and symptomatic history.

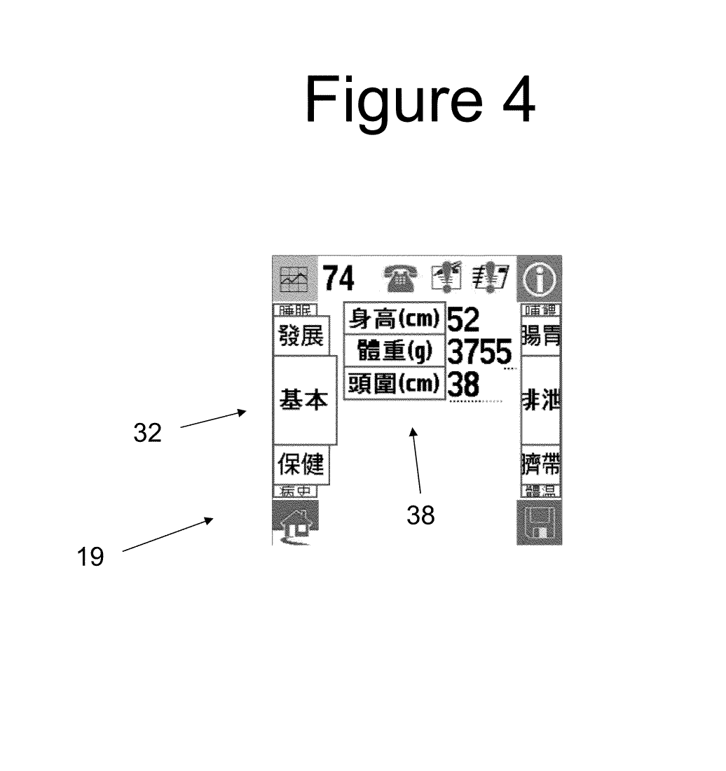

FIG. 4 shows the effect of drilling down by tapping the uppermost full region 52 in FIG. 3. In response, the display shown in the working layer 38 has changed to show certain information about the user.

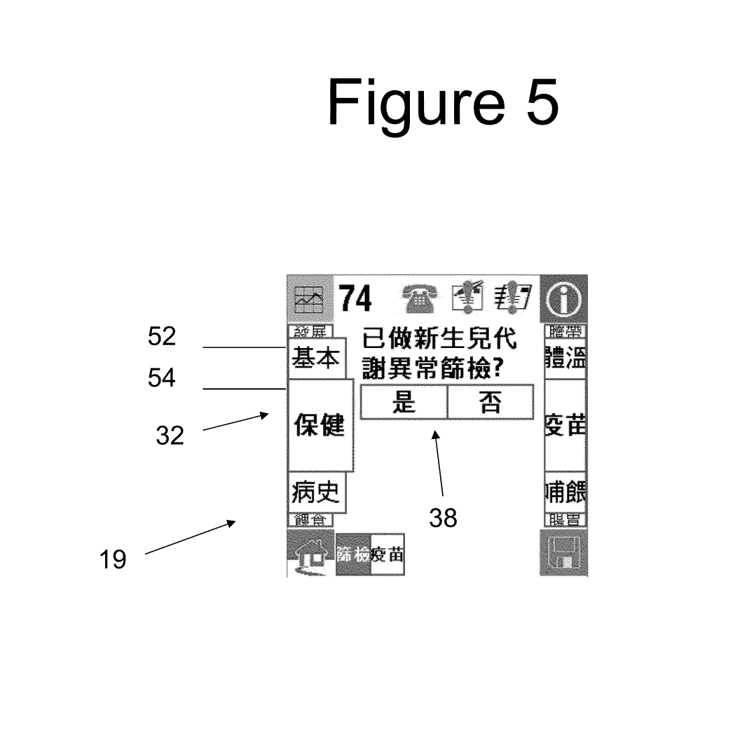

FIG. 5 shows the effect of drilling down by tapping the second full region 54 in FIG. 3. In this case, the working layer 38 has changed to solicit information about the user's health. Information provided by the user, by tapping on a region 56 in the working layer 38, is then provided to the tail-end 18.

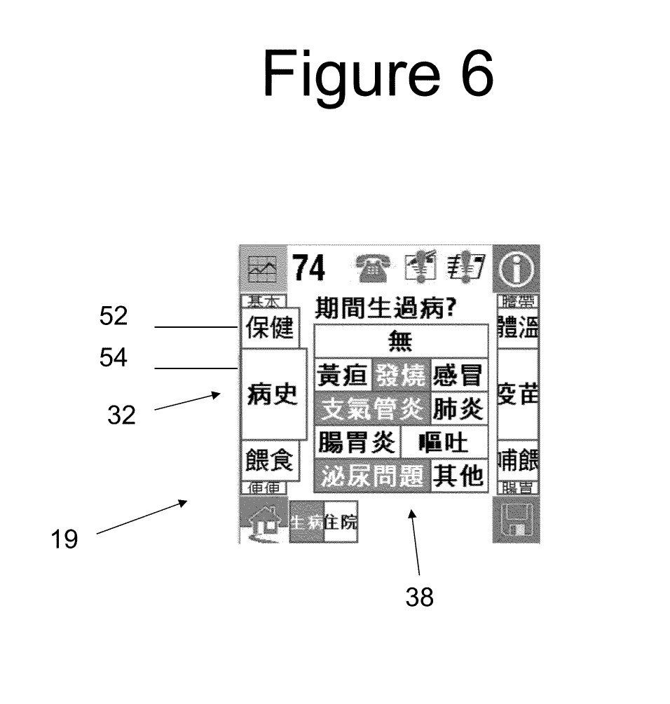

FIG. 6 shows another exemplary collection interface 19 for soliciting information in an embodiment specifically directed to health care. In this example, the collection interface 19 solicits information about any symptoms experienced by the user. The working layer 38 in this case provides a list of symptoms. By tapping on selected regions within the working layer 38, the user causes relevant information to be transmitted to the tail-end 18 for storage in the user database 31.

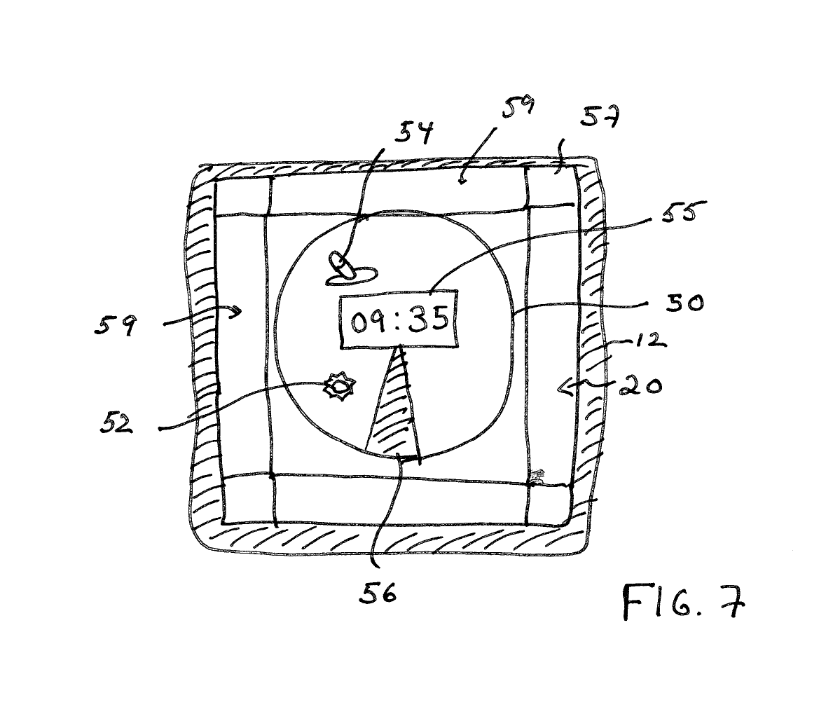

Referring to FIG. 7, one embodiment of an activity programming interface 20 includes a circular activity map 50 that places activity icons 52, 54 at positions that correspond to time. In the particular embodiment shown, angle represents time. Preferably, a clock 55 showing the actual time is placed within the circular activity map 50.

The activity programming interface 20 further includes four menu buttons 57, one at each of four corners of the display, and four hot edges 59 extending between pairs of menu buttons 57 and along the sides of the display. The menu buttons 57 and hot edges 59 can be used to access various options and functions, the details of which are application-specific.

The 360 degrees of the circular activity map 50 represent some convenient interval, such as 8 hours, 12 hours, or 24 hours. The interval is application-dependent and can depend on the number of activities and the intervals between them.

Different programmed activities are represented by activity icons 52, 54. These activity icons 52, 54 are placed at locations within the activity map 50 that correspond to the times at which the activities they represent are to occur. For example, if a user is to take a particular medication at a particular time, the icon might be a picture of the pill, as is the case in FIG. 7, which is disposed at a location corresponding to that angle.

Although the icons can be graphical representations of an activity, it is also possible for the icon to simply show a number or letter. In either case, the user merely taps on the icon to temporarily transform the programming interface into the state shown in FIG. 2 to see a description of the relevant activity.

The icon can be configured such that tapping the icon communicates completion of the activity back to the tail-end 18. In response to failure to receive a completion signal, the tail-end 18 can also be configured to transmit an alarm signal to the head-end 14 to alert the user to his non-compliance and to reconfigure or otherwise change the activity icons 52, 54 in response to such non-compliance.

The program interface further includes an indicator 56 whose position on the circular activity map 50 depends on time. In the illustrated embodiment, the indicator 56 is a radially-extending feature that extends at an angle that depends on time. The indicator 56 sweeps around the circular activity map 50 at a rate consistent with elapsed time. In doing so, the indicator 56 highlights particular activity icons 52, 54 on the display.

In some embodiments, as shown in FIG. 7, the indicator 56 is a radially-extending moving wedge that sweeps around the activity map 50 at a rate indicative of elapsed time. In this embodiment, the indicator 56 highlights a range of times corresponding to the angular extent of the moving wedge. This indicator 56 can thus be used to highlight particular activity icons, to hopefully remind the user to carry out the activity associated with the activity icon.

A variety of ways are provided to remind the user of an impending activity. In some embodiments, the color of the activity map 56 changes as the remaining time to an activity diminishes. For instance, a normally green activity map 56 might change to yellow when the remaining time falls below a threshold and then change to red when the remaining time falls below a second threshold. The thresholds can be constant across all kinds of activities, or they can be tailored to suit the nature of the activity. Or, one or more activity icons 52, 54 can change appearance, for example, change color or intensity, to apprise the user of an impending activity.

In other embodiments, the activity map 56 includes a count-down timer 64 that indicates time remaining until the next activity is due. The count-down timer 64 can be present at all times, or it can be made to appear when the time remaining until the next activity has diminished to a third threshold.

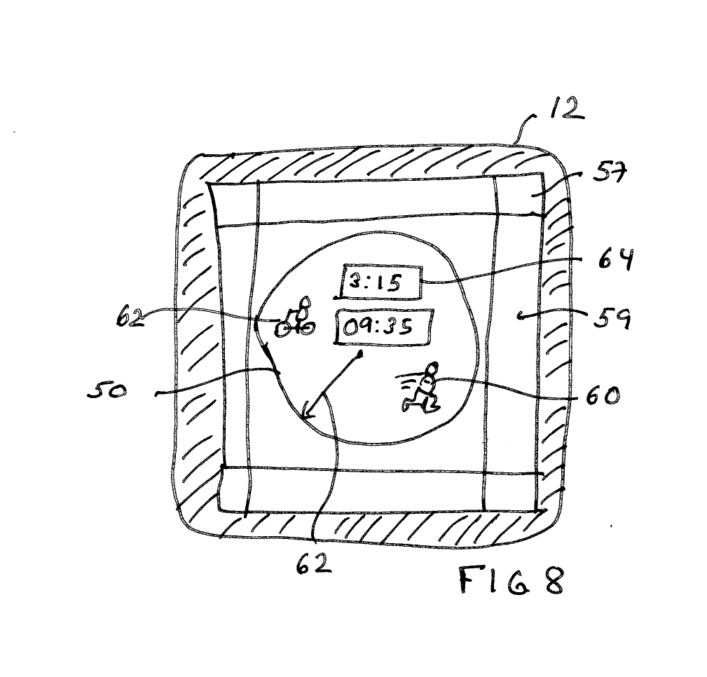

FIG. 8 is an example of a user program interface 20 as described in connection with FIG. 7 but in which the icons 58, 60 denote types of exercise rather than types of medication. In this embodiment, the indicator 62 is a radially-extending line rather than a radially-extending wedge.

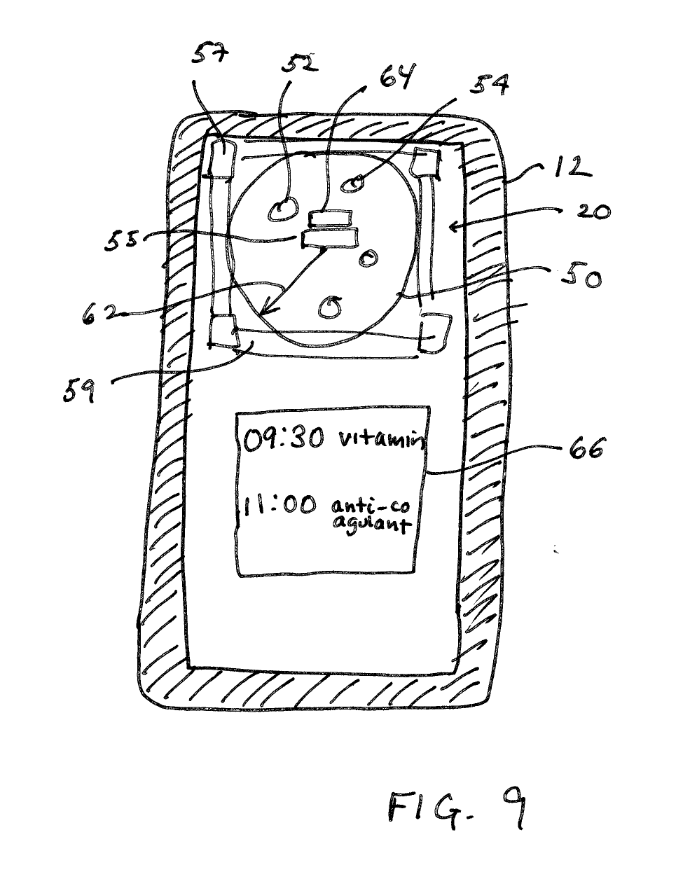

FIG. 9 shows an alternative embodiment optimized for a display having a more rectangular aspect ratio. The illustrated display provides additional space for an auxiliary component 66 that can be used to provide an activity list or additional documentation concerning an activity.

Information for selection of and placement of icons 52, 54, 56, 58 is communicated to the mobile device 12 from the program changer 30 via the cloud 24 and updated as necessary. For instance, as time progresses, new icons may appear and icons representing completed activities may disappear.

In addition, the activity programming system provides a way to dynamically modify the activity program in response to changing conditions. For example, in a health care delivery embodiment, the user may forget to take his medication at a prescribed time. Depending on the nature of the condition, the knowledge base 28 may instruct the program changer 30 to change the next time at which the medication should be taken. Or, if the monitoring center 26 recognizes an abrupt increase in blood pressure, the knowledge base 28 may instruct the program changer 30 to modify the time at which the next medication should be taken or to modify the dosage. In some cases, the activity programming system 10 will alert a doctor, who can then manually provide instructions for changing the activity program.

Having described the invention, and a preferred embodiment thereof, what I claim as new and secured by Letters Patent is:

1. An apparatus for providing a user program to a user said apparatus comprising a mobile device configured to execute thereon a head end of an application for collecting user information and for providing a user program interface for delivery of user program information to said user, and a server in wireless data communication with said mobile device for providing user programming information thereto, said user programming being selected at least in part on the basis of said user information collected by said mobile device.

2. The apparatus of claim 1, wherein the server includes a knowledge base for assessing said solicited user information and providing changes in program instructions to said mobile data in response to said user information.

3. The apparatus of claim 1, wherein the mobile device is configured to execute a programming interface for displaying a user program to said user.

4. The apparatus of claim 3, wherein the programming interface comprises an activity map calibrated to represent a certain time interval.

5. The apparatus of claim 4, wherein the programming interface further comprises an icon disposed at a location in said activity map, said location representing a time at which an activity corresponding to said icon is to occur.

6. The apparatus of claim 4, wherein said activity map comprises a circular region.

7. The apparatus of claim 4, further comprising an indicator on said activity map, said indicator being configured to change position on said activity map in response to passage of time.

8. The apparatus of claim 4, wherein said icon is placed on said activity map at least in part in response to collected user information.

9. The apparatus of claim 4, wherein said location of said icon changes at least in part based on collected user information.

10. The apparatus of claim 5, wherein the icon disappears after the time at which the activity it represents has occurred.

11. The apparatus of claim 1, wherein said mobile device is configured to execute an interface for collecting user information, said interface comprising an active corner region and an active side region, wherein said active corner region and said active side region each execute corresponding instructions in response to actuation by said user.

12. The apparatus of claim 1, wherein said mobile device is configured to execute an interface for collecting user information, said interface comprising a plurality of active corner regions and a plurality of active side regions, each side region extending between two of said active corner regions, wherein said active corner regions and said active side regions each execute corresponding instructions in response to actuation by said user.

13. An apparatus for providing a user program to a user said apparatus comprising a server in wireless data communication with a mobile device for providing user programming information thereto, said user programming being selected at least in part on the basis of user information collected by said mobile device.

14. A computer-readable medium having encoded thereon software for providing a user program to a user, said software including instructions for providing, to a mobile device, user programming selected at least in part on the basis of user information collected by said mobile device.

15. A computer-implemented method for providing a user program to a user, said method comprising establishing communication with a mobile device configured to execute thereon a head end of an application for collecting user information and for providing a user program interface for delivery of user program information to said user, and providing user programming information to the mobile device, said user programming being selected at least in part on the basis of said user information collected by said mobile device.

16. The method of claim 15, further comprising providing a knowledge base for assessing said solicited user information, and providing changes in program instructions to said mobile data in response to said user information.

17. The method of claim 15, further comprising displaying a user program to said user.

18. The method of claim 17, wherein displaying a user program comprises displaying an activity map calibrated to represent a certain time interval.

19. The method of claim 18, wherein displaying a user program comprises displaying an icon disposed at a location in said activity map, said location representing a time at which an activity corresponding to said icon is to occur.

20. The method of claim 18, wherein displaying a user program comprises placing an icon on said activity map at least in part in response to collected user information.

21. The method of claim 18, wherein displaying a user program comprises placing an icon on said activity map at a location based at least in part based on collected user information.

22. The method of claim 13, further comprising, in response to user actuation of an active corner region on said mobile device, executing first instructions, and in response to a user actuation of an active side region on said mobile device, executing second instructions.

23. The method of claim 1, further comprising, in response to user actuation of any one of plural corner regions, executing instructions corresponding to said actuated corner region, and in response to user actuation of any of a plurality of side regions, each of which extends between two of said active corner regions, executing user instructions corresponding to said actuated side region.
